(19) United States
(12) Patent Application Publication
(10) Pub. No.: US 2026/0310661 A1
(43) Pub. Date: Oct. 8, 2026

(54) METHODS AND SYSTEMS FOR ENABLING FLEXIBLE QUERY PROCESSING IN NETWORK-BASED COMMUNICATION PROTOCOLS

(71) Applicant: Apaluma LLC, Albuquerque, NM (US)

(72) Inventors: Tilan Ukwatta, Tulsa, OK (US); Alicia Keyes, Albuquerque, NM (US)

(21) Appl. No.: 19/326,562

(22) Filed: Sep. 11, 2025

Related U.S. Application Data
(60) Provisional application No. 63/712,185, filed on Oct. 25, 2024.

(51) Int. Cl. G06F 16/242; H04L 67/56

(52) U.S. Cl. CPC G06F 16/2448; G06F 16/243; H04L 67/56

(57) ABSTRACT

A RESTQuery method and system can be implemented, which enhances REST APIs by introducing efficient querying capabilities, while preserving the simplicity and flexibility of traditional REST architectures. Through a “restquery” parameter, clients can specify exactly what data they require, thereby reducing over-fetching and under-fetching, and improving performance in client-server interactions. The system can also support natural language prompts, making it more dynamic and customizable for users.

### CROSS REFERENCE TO PATENT APPLICATION

This patent application claims priority under 35 U.S.C. § 119 to U.S. Provisional Patent Application Ser. No. 63/712,185 entitled “RESTQuery: Queryable Smart REST APIs,” which was filed on Oct. 25, 2024, and is incorporated herein by reference in its entirety.

### TECHNICAL FIELD

Embodiments are related to flexible query processing in network-based communication protocols. Embodiments also relate to application programming interfaces (APIs) and, more particularly, to systems and methods for querying REST (Representational State Transfer) APIs in a dynamic and flexible manner while maintaining the simplicity and scalability of traditional RESTful architectures.

### BACKGROUND

REST APIs have become a popular architecture for enabling communication between different software systems, using HTTP protocols to send requests for accessing, modifying, or deleting resources on a server. RESTful APIs are highly favored for their simplicity, scalability, and stateless nature, which ensures that each client request contains all necessary information, independent of any previous requests. However, despite these advantages, REST APIs have significant limitations when it comes to querying specific or relational data. Retrieving data from deeply nested structures or filtering results across multiple criteria can be inefficient, requiring multiple round-trip requests between clients and servers. This results in challenges such as over-fetching or under-fetching data, where clients either receive more data than necessary or insufficient data, necessitating further requests.

GraphQL, an alternative to REST, addresses some of these limitations by enabling clients to request specific data in a single query. However, GraphQL introduces complexities in terms of schema design, query management, and backend redesign and performance optimization. Furthermore, caching and security are more complicated with GraphQL, making it more challenging to implement and maintain compared to traditional REST APIs.

Thus, there is a need for a solution that preserves the simplicity of REST while offering the querying capabilities of GraphQL.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the embodiments to provide for methods and systems for flexible query processing in network-based communication protocols.

It is another aspect of the embodiments to provide methods and systems that preserve the simplicity of REST while offering the querying capabilities of GraphQL

It is another aspect of the embodiments to provide for methods and systems that can bridge the gap in data retrieval by introducing queryable smart REST APIs.

It is yet another aspect of the embodiments to provide for a RESTQuery proxy that intercepts HTTP requests and dynamically interprets an optional “restquery” parameter to tailor the structure and content of REST API responses.

It is still another aspect of the embodiments to enable clients to specify, via a “restquery” parameter, specific data fields or components they wish to extract from a standard REST API response.

It is also an aspect of the embodiments to support natural language instructions within the “restquery” parameter, thereby enhancing accessibility for non-technical users and promoting more intuitive API interactions.

It is a further aspect of the embodiments to provide for validation mechanisms within the RESTQuery proxy to ensure the relevance, security, and syntactic integrity of the “restquery” parameter before query execution.

The aforementioned aspects and other objectives and advantages can now be achieved as described herein.

In an embodiment, a system also referred to as RESTQuery can be implemented, which can enhance traditional REST APIs with dynamic querying capabilities, similar to but not as cumbersome as that provided by GraphQL, while retaining the simplicity and stateless architecture of REST. RESTQuery operates as a proxy between the client and the REST API server, allowing clients to make more efficient queries using an additional query parameter called “restquery.” This can be in the form of a query parameter in the URL or in the body of the URL.

When the client sends a request to the server, it can optionally include the “restquery” parameter, which specifies the exact fields or resources needed from the standard REST API response. RESTQuery can interpret this query parameter and processes the request before passing it on to the REST API server. Once the server responds, the RESTQuery system can modify the response according to the query and send it back to the client.

Additionally, the RESTQuery system can support natural language prompts in the “restquery” parameter, enabling clients to send smart, customized requests. The system can be designed to ensure that these prompts are relevant to the REST API's scope, otherwise it can raise an error.

Due to its dynamic nature, RESTQuery APIs can include a new API specification format, which can be based on but distinct from the OpenAPI specification.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of a REST API architecture, in accordance with an embodiment;

FIG. 2. Illustrates a block diagram of REST API limitations, in accordance with an embodiment;

FIG. 3 illustrates a block diagram of a GraphQL architecture, in accordance with an embodiment;

FIG. 4 illustrates a block diagram of a RESTQuery architecture, in accordance with an embodiment;

FIG. 5 illustrates a block diagram of a system including a RESTQuery proxy system disposed between a client and a REST API server, in accordance with an embodiment;

FIG. 6 illustrates a diagram wherein an optional “restquery” query can be introduced into a regular REST API request, in accordance with an embodiment;

FIG. 7 illustrates a flow diagram for operations within a RESTQuery system wherein detection of a “restquery” query parameter dictates query processing, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part. In addition, identical reference numerals utilized herein with respect to the drawings can refer to identical or similar parts or components.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

As utilized herein, RESTful communication can relate to the interaction between a client and a server based on the principles of Representational State Transfer (REST), an architectural style designed for scalable and stateless communication over the web. In a RESTful system, resources—such as data objects or services—are identified by unique Uniform Resource Identifiers (URIs), and these resources are manipulated through a standardized set of HTTP methods, including GET, POST, PUT, and DELETE. Each client request must be self-contained, meaning it includes all the information necessary for the server to understand and process it without relying on any stored context from previous interactions. This stateless nature promotes scalability and simplicity, as the server does not retain session information.

Clients can interact with resources by requesting or sending representations, typically in formats such as JSON or XML. The server returns data that reflects the current state of the requested resource, and clients can update or delete resources by issuing the appropriate HTTP methods. RESTful communication emphasizes a uniform interface, enabling consistent and predictable interactions across different systems. In addition, RESTful responses can be explicitly marked as cacheable, allowing clients or intermediaries to store and reuse data where appropriate, thereby improving efficiency and reducing server load.

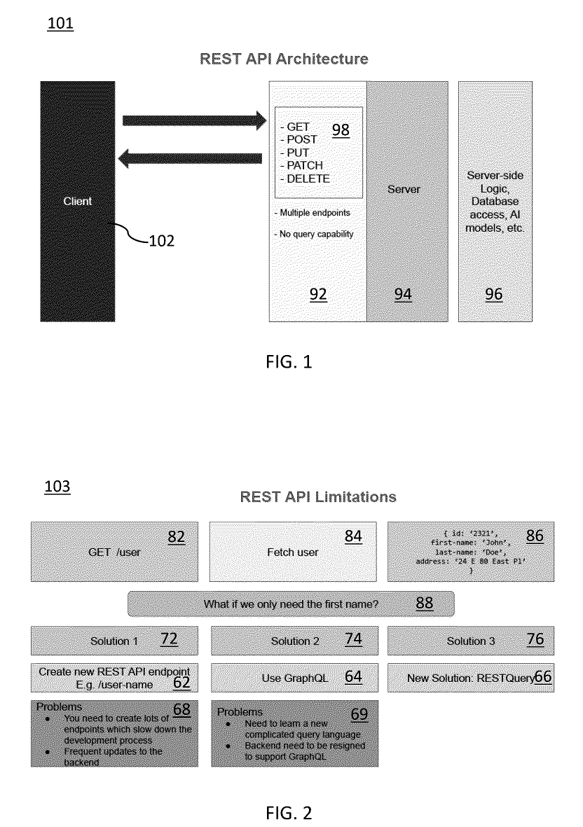

FIG. 1 illustrates a block diagram of a REST API architecture 101, in accordance with an embodiment. The REST API architecture 101 shown in FIG. 1 includes a client that can communicate bidirectionally with a portion 92 that can be integrated with and/or connected to a server 94. The server 94 can also include a section 96 comprising server side logic, database access, AI models, etc.

FIG. 2 illustrates a block diagram depicting the limitations of a conventional REST API 103, in accordance with an embodiment. FIG. 2 depicts challenges that developers and clients may face when attempting to retrieve specific subsets of data using traditional RESTful architectures. As shown in FIG. 2, a typical REST API 103 request such as GET/user (see block 82) can result in a general data-fetching operation (see block 84) that retrieves a full user object based on an identifier (see block 86). This user object may include multiple fields such as first name, last name, mailing address, email, and other personal data. However, in many practical scenarios, a client may only require a subset of this data, such as just the user's first name. This situation is visually represented in block 88, which poses the question: “What if we only need the first name?”

In response to this challenge, FIG. 2 depicts three potential solutions, shown as blocks 62, 64, and 66. One approach (block 62) involves creating a new REST API endpoint, such as/user-name, specifically designed to return only the user's name. While functionally effective, this solution can lead to endpoint proliferation, requiring the creation and maintenance of numerous narrowly tailored endpoints, which burdens development teams and complicates version control. A second option (block 64) may involve adopting GraphQL, a more flexible query language that allows clients to specify the exact fields needed. However, this approach presents its own set of technical barriers, including the need for backend refactoring, performance tuning, and learning a new, complex query syntax.

Block 66 introduces a new solution (RESTQuery), which provides an intelligent, proxy-based approach that allows clients to query specific data fields using an optional parameter (e.g., “restquery”) without altering the underlying REST API endpoints. RESTQuery preserves the stateless and simple nature of REST while addressing its key limitations.

Finally, blocks 68 and 69 summarize the problems associated with traditional and GraphQL-based approaches. Block 68 indicates that creating multiple dedicated endpoints slows development and increases backend maintenance, while block 69 highlights that adopting GraphQL often requires significant changes to backend architecture and the need for developers to learn a new query model. Together, these limitations underscore the need for the RESTQuery approach described in further detail below.

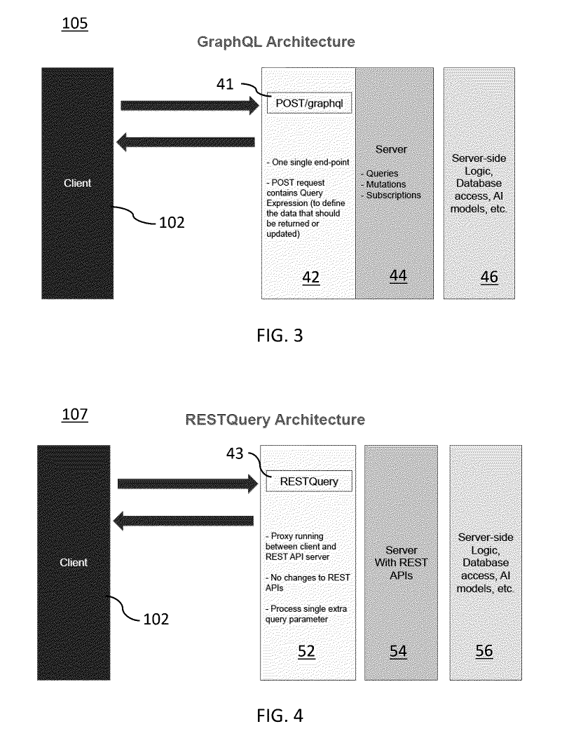

FIG. 3 illustrates a block diagram of a GraphQL architecture 105, in accordance with an embodiment. In the embodiment depicted in FIG. 3, the GraphQL architecture 105 can include the client 102, which can communicate with a server 44 and a section 42 that can function as a single endpoint, and in which a POST request can contain query expression (to define the data that should be returned or updated). Section 42 handles Post/graphQL. Section 42 is associated with or contained in or processed by the server 44. Note that the server 44 handles queries, mutations, and subscriptions. Server 44 also can function as a portion or section 46 that includes server-side logic, database access, AI models, etc.

Note that as utilized herein, the term “GraphQL” or “Graphql” and variations thereof can relate to a query language and runtime environment for application programming interfaces (APIs) that was developed by Facebook and released as an open-source project. GraphQL provides a structured and declarative approach to retrieving data from server-side resources by allowing clients to specify exactly what data is needed in a single request. Unlike traditional REST architectures where each endpoint returns a fixed data structure, GraphQL enables clients to query multiple resources in a single, unified request and define the precise shape of the response, thereby minimizing issues such as over-fetching or under-fetching of data.

A GraphQL architecture can include three primary components: (1) a GraphQL schema, which defines the types of data and relationships available; (2) a GraphQL query language, which clients use to construct requests based on the schema; and (3) a GraphQL execution engine, which can interpret incoming queries, resolves the requested fields (often through resolver functions mapped to data sources or services) and can return a structured response, usually in, for example, JSON format.

FIG. 4 illustrates a block diagram of a RESTQuery architecture 107, in accordance with an embodiment. The RESTQuery architecture 107 includes the client 102, which communicates bidirectionally with the server 54 (i.e., Server with REST APIs). The server 54 includes or handles the operations associated with section 52, which handles proxy running between the client and REST API server. Here, no changes are made to REST APIs. Furthermore, section 52 illustrates processing of a single extra query parameter. The server 54 also involves or handles server-side logic, database access, AI models, etc. as shown at block 56. FIG. 4 thus depicts a high-level architecture and operational flow of a RESTQuery system, which can be designed to enhance traditional REST API interactions.

### System Architecture

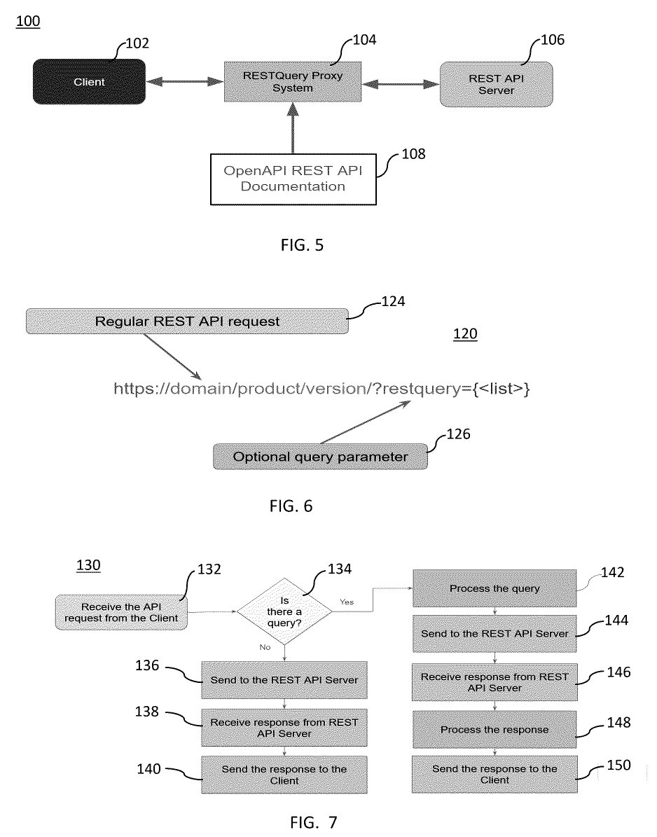

Referring to FIG. 5, a block diagram of a system 100 is depicted, wherein a RESTQuery proxy system 104 can be disposed between a client 102 and a REST API server 106, in accordance with an embodiment. The system 100 functions as a RESTQuery system and comprises three principal components: the client 102, the RESTQuery proxy system 104, and the REST API server 106. The client 102 may be any computing system or software application capable of initiating HTTP-based communication. In various implementations, the client 102 may include, but is not limited to, web browsers, mobile applications, desktop applications, automated scripts, or server-side processes. The client 102 transmits HTTP requests to the RESTQuery proxy system 104, which acts as an intermediary layer between the client and the backend REST API server 106. These requests may include standard HTTP verbs such as GET, POST, PUT, or DELETE, as well as additional metadata or query parameters, including a “restquery” parameter that enables advanced querying behavior.

The RESTQuery proxy system 104, also referred to as a “RESTQuery proxy” or simply a proxy, can operate as an “intelligent” middleware layer positioned logically and/or physically between the client 102 and the REST API server 106. In some embodiments, the RESTQuery proxy 104 is implemented as a standalone proxy server or reverse proxy, while in other embodiments it may be integrated within an API gateway or edge computing node.

Note that as utilized herein the term “intelligent” can relate to the ability of the RESTQuery proxy system to perform context-aware processing, decision-making, or transformation of data based on configurable rules, semantic interpretation, or dynamic input from client queries. An “intelligent” proxy is capable of more than simple request forwarding; it can analyze the contents of incoming requests, including optional parameters such as a Rest Query field, interpret client-specified criteria, validate and transform queries, and modify the server's response accordingly before delivering it to the client. This intelligence may be implemented using deterministic logic, machine learning models, natural language processing, or structured query interpretation techniques, enabling the proxy to respond adaptively to a wide range of client instructions while preserving the stateless nature of the underlying REST architecture.

The RESTQuery proxy 104 can be configured to intercept incoming HTTP requests from the client 102 and to inspect the content of each request to determine whether it includes an optional “restquery” parameter. This “restquery” parameter may contain structured instructions, such as, for example, field selection, filtering criteria, sorting, pagination directives, or even natural language expressions—intended to customize or refine the data returned from the REST API server 106. Upon detecting the “restquery” parameter, the proxy system 104 parses and processes the parameter to dynamically modify the behavior of the request, the structure of the response, or both.

In a typical flow, the RESTQuery proxy 104 can forward an unaltered or slightly modified HTTP request to the REST API server 106 and can receive a standard API response in return. Before relaying this response back to the client 102, the proxy 104 transforms the data according to the instructions specified in the “restquery” parameter. This may involve filtering specific fields, flattening nested data structures, aggregating results, or restructuring the data to fit a particular schema preferred by the client. In this manner, the RESTQuery proxy 104 can enable more flexible and client-driven interactions with REST APIs, while maintaining compatibility with traditional RESTful architectures and backend services. Additionally, this layered approach can reduce the need for duplicative or verbose API endpoints, minimizes data over-fetching and under-fetching, and improves performance and usability across a range of applications and client devices.

FIG. 5 thus presents a block diagram of RESTQuery API architecture, showing the arrangement of the client, the RESTQuery proxy, and the backend REST API server. FIG. 5 highlights how the proxy sits between the client and server to mediate and customize API responses based on client-specified query parameters.

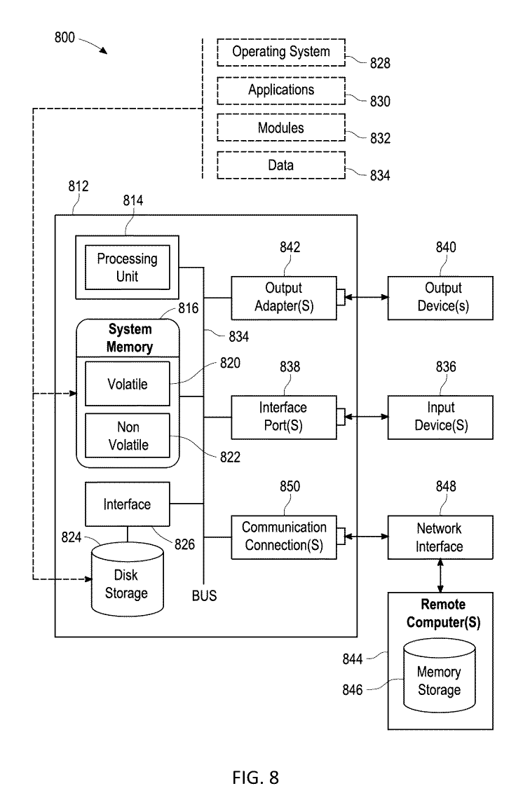

FIG. 6 illustrates a schematic diagram of an architecture 120 wherein an optional “restquery” query parameter 126 can be introduced into a regular REST API request 124, in accordance with an embodiment. The configuration depicted in FIG. 6 illustrates how the optional “restquery” parameter 126 can be seamlessly introduced into the standard REST API request 124.

FIG. 6 illustrates how an optional restquery parameter may be embedded into a standard REST API request and how the proxy modifies server responses, accordingly, allowing for advanced querying functionality without modifying the backend API itself.

In a conventional REST API interaction, a client may send a request to a server, often using a URI that identifies a resource and may include additional query parameters such as filtering conditions, pagination controls, or sorting options. In the RESTQuery proxy system 104, an additional layer of flexibility can be introduced by allowing the client 102 to append an optional restquery parameter, either as a query string in the URL, within the body of a POST or PUT request, or even in a custom HTTP header. This restquery parameter can encapsulate enhanced querying instructions that are not natively supported by the underlying REST API, enabling clients to request more specific or transformed data without requiring changes to the REST API's endpoint structure or logic.

Once the request is sent, it can be intercepted by the RESTQuery proxy system 104, which inspects the contents of the request for the presence of the restquery parameter. If present, the RESTQuery proxy system 104 can interpret the contents of the parameter, which may be encoded in a structured format such as JSON or a lightweight domain-specific language, and can use it to determine how the response from the backend REST API server should be processed or modified. This allows clients such as the client 102 to exert fine-grained control over the structure and content of the response data. For example, the client 102 may specify that only certain fields should be included, that results should be grouped by a particular key, or that only nested records matching certain criteria should be returned.

The REST API server 106 in the configuration shown in FIG. 5 can function as a backend server responsible for hosting and managing the core RESTful services. The REST API server 106 can process incoming HTTP requests and returns standard responses based on the request URI and parameters. Importantly, the REST API server 106 may not be required to be aware of the restquery parameter; it continues to operate in a standard stateless manner, accepting and responding to requests as usual. The RESTQuery proxy 104 handles all logic related to interpreting and acting upon the restquery parameter, thereby decoupling advanced querying behavior from the backend infrastructure. This design allows for backward compatibility with existing REST APIs, minimizes disruption to legacy systems, and enables immediate enhancement of API capabilities without requiring changes to the existing endpoints or their implementation.

The architecture shown in FIG. 4 preserves the simplicity and scalability of traditional RESTful communication while introducing a flexible mechanism for clients to specify how they want data to be returned, without burdening the backend server or increasing the number of discrete API endpoints.

### Operation

FIG. 7 illustrates a flow diagram depicting logical operational steps of a method 130, which can be implemented within a RESTQuery system such as the system 100 depicted in FIG. 5, wherein detection of a “restquery” query parameter can dictate query processing, in accordance with an embodiment. The flow diagram depicted in FIG. 7 depicts end-to-end Processing steps, including the client request, interception and interpretation by the proxy, request forwarding to the API server, and post-processing of the response before delivery back to the client

Standard REST API Request. As shown at block 132, as step or operation can be implemented to receive an API request from the client 102 of FIG. 5. When a client such as the client 102 sends a standard request without the “restquery” parameter, the RESTQuery proxy simply forwards the request to the REST API server and returns the unmodified response to the client 102, maintaining compatibility with the traditional REST API workflow.

Thereafter, a test can be performed as shown at decision block 134 to determine if there is a query. Assuming the result of the test is “yes”, i.e., there is a query, then the operations depicted at blocks 142 to 150 can be implemented. If not or “no”, then the operations shown at blocks 136, 138, and 140 are implemented.

Query with “restquery” Parameter. If the request includes the optional “restquery” query parameter, the system 100 processes the query parameter, as shown at block 142 before forwarding the request to the REST API server 106, as indicated at block 144. The “restquery” parameter can allow the client to specify which portions of the API response it needs. Depending on the API's structure, the format of this query parameter can vary but may be documented in the RESTQuery API specification. Following processing of the operation shown at block 144, an operation can be implemented as shown at block 146 in which a response can be received from the REST API server 106. The response can be then processed, as shown at block 148, followed by the response sent to the client 102, as indicated at block 150.

As noted above, assuming the result of the test performed as shown at decision block 134 is “no”, a step or operation can be implemented to send the query to the REST AP server 106. Next, as shown at block 136, a step or operation can be implemented in which a response can be received by the REST API server 106. The response can be then sent to the client 102, as illustrated at block 140.

Processing Response. Once the REST API server 106 responds, the RESTQuery proxy modifies the response based on the “restquery” instructions and forwards the refined response to the client 102. This process can eliminate over-fetching or under-fetching of data, making the API interaction more efficient.

Natural Language Querying. RESTQuery can also support natural language queries through the “restquery” parameter. The client can send natural language instructions, and the system will interpret and process these instructions to generate a relevant API query. If the instruction is outside the scope of the REST API's capabilities or structure, the system raises an error, preventing invalid requests.

### Query Management

RESTQuery provides dynamic querying capabilities akin to GraphQL but with the simplicity of REST. Clients can request specific data points without needing multiple round-trip requests, thereby optimizing bandwidth and performance. The querying mechanism is flexible enough to handle deeply nested structures, filtering, and custom criteria.

Security and Error Handling. Since RESTQuery allows clients to send customized queries and natural language instructions, the system incorporates robust security measures. The system can verify that each query or instruction can be relevant to the API's structure and can validate before forwarding requests to the server. Additionally, RESTQuery can include mechanisms for rate-limiting, query validation, and error handling to protect against resource-intensive or malicious queries.

### RESTQuery Specification

Given the dynamic and flexible nature of RESTQuery, it is incompatible with traditional OpenAPI specifications. Therefore, a new specification format, based on OpenAPI but adapted to support RESTQuery's functionality, can be developed. This specification can define how clients can interact with the RESTQuery API, including the formats for the “restquery” parameter and natural language instructions.

Note that each of the illustrated components or blocks such as illustrates and described herein may be implemented as modules. Although not required, the disclosed embodiments can be described in the general context of computer-executable instructions, such as program modules, being executed by a single computer or a group of computers. In most instances, such a “module” or component may constitute a software application but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines, and an implementation, which may be typically private (accessible only to that module) and which includes source code that actually implements the routines in the module. The term module may also simply refer to an application, such as a computer program designed to assist in the performance of a specific task, such as word processing, accounting, inventory management, etc.

In some example embodiments, the term “module” can also refer to a modular hardware component or a component that is a combination of hardware and software. It should be appreciated that implementation and processing of such modules or components according to the approach described herein can lead to improvements in processing speed and in energy savings and efficiencies in a data-processing system such as, for example, the systems described previously/above and/or the operating environment 800 discussed below with respect to FIG. 8. The various components of the embodiments when integrated as disclosed herein may lead to improvements in, for example, data retrieval speed and a reduction in latency.

Although the operations of the methods and systems herein are shown and described in a particular order, the order of the operations may be altered so that certain operations may be performed in an inverse order or so that certain operations may be performed, at least in part, concurrently with other operations. In another embodiment, instructions or sub-operations of distinct operations may be implemented in an intermittent and/or alternating manner.

At least some of the operations of the methods and systems described herein can be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), a digital video disk (DVD), Flash memory, and so on.

Alternatively, embodiments of the invention may be implemented in hardware or in an implementation containing hardware and software elements. In embodiments that do utilize software, the software may include firmware, resident software, microcode, etc.

The functionalities described herein may be implemented entirely and non-abstractly as physical hardware, entirely as physical non-abstract software (including firmware, resident software, micro-code, etc.) or combining non-abstract software and hardware implementations that may all generally be referred to herein as a “circuit,” “module,” “engine”, “component,” “block”, “database”, “apparatus” or “system.” Furthermore, aspects of the present disclosure may take the form of a computer program product embodied in one or more non-ephemeral computer readable media having computer readable and/or executable program code embodied thereon.

FIG. 8 illustrates an example of a suitable operating environment 800 for implementing various aspects of this disclosure and which can also include a computer 812. The computer 812 can also include a processing unit 814, a system memory 816, and a system bus 834. The system bus 834 couples system components including, but not limited to, the system memory 816 to the processing unit 814. The processing unit 814 can be any of various available processors. Dual microprocessors and other multiprocessor architectures also can be employed as the processing unit 814.

The system bus 834 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1094), and Small Computer Systems Interface (SCSI). The system memory 816 can also include volatile memory 820 and nonvolatile memory 822. The basic input/output system (BIOS), containing the basic routines to transfer information between elements within the computer 812, such as during start-up, is stored in nonvolatile memory 822.

By way of illustration, and not limitation, nonvolatile memory 822 can include read only memory (ROM), programmable ROM (PROM), electrically programmable ROM (EPROM), electrically erasable programmable ROM (EEPROM), flash memory, or nonvolatile random-access memory (RAM) (e.g., ferroelectric RAM (FeRAM). Volatile memory 820 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 812 can also include removable/non-removable, volatile/non-volatile computer storage media. FIG. 8 illustrates, for example, a disk storage 824. Disk storage 824 can also include, but is not limited to, devices like a magnetic disk drive, floppy disk drive, tape drive, Jaz drive, Zip drive, LS-100 drive, flash memory card, or memory stick. The disk storage 824 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 824 to the system bus 834, a removable or non-removable interface is typically used, such as interface 826.

FIG. 8 also depicts software that can act as an intermediary between users and the basic computer resources described in the suitable operating environment 800. Such software can also include, for example, an operating system 828. Operating system 828, which can be stored on disk storage 824, acts to control and allocate resources of the computer 812. System applications 830 can take advantage of the management of resources by operating system 828 through program modules 832 and program data 834, e.g., stored either in system memory 816 or on disk storage 824. It is to be appreciated that this disclosure can be implemented with various operating systems or combinations of operating systems.

A user can enter commands or information into the computer 812 through input device(s) 836. Input device(s) 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices can connect to the processing unit 814 through the system bus 834 via interface port(s) 838. Interface port(s) 838 can include, for example, a serial port, a parallel port, a game port, and a universal serial bus (USB). Output device(s) 840 may use some of the same type of ports as input device(s) 836.

Thus, for example, a USB port can be used to provide input to computer 812, and to output information from computer 812 to an output device 840. Output adapter 842 is provided herein to illustrate that there may be some output devices 840 like monitors, speakers, and printers, among other output devices 840, which require special adapters. The output adapters 842 include, by way of illustration and not limitation, video and sound cards that provide a means of connection between the output device 840 and the system bus 834. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a computer, a server, a router, a network PC, a workstation, a microprocessor-based appliance, a peer device or other common network node and the like and typically can also include many or all the elements described relative to computer 812. For purposes of brevity, only a memory storage device 846 is illustrated with remote computer(s) 844. Remote computer(s) 844 can be logically connected to computer 812 through a network interface 848 and then can be physically connected via communication connection 850.

Network interface 848 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 850 refers to the hardware/software employed to connect the network interface 848 to, for example, the system bus 834. While communication connection 850 is shown for illustrative clarity inside computer 812, it can also be external to the computer 812. The hardware/software for connection to the network interface 848 can also include, for exemplary purposes only, internal and external technologies such as, modems including regular telephone grade modems, cable modems and DSL modems, ISDN adapters, and Ethernet cards.

The operating environment illustrated in FIG. 8 relates depicts an exemplary hardware and software platform capable of implementing the RESTQuery proxy system and its associated components. As described in this disclosure, the RESTQuery proxy functions as an intelligent middleware layer positioned between a client and a REST API server, performing dynamic query interpretation, validation, and response transformation. These operations can be executed within a computing environment like that shown in FIG. 8, where a computer 812 includes a processing unit, memory, storage, and network interfaces.

The RESTQuery proxy logic, whether deployed as a standalone proxy server, integrated API gateway, or distributed edge node, can be implemented in software running on such computing devices, which leverage the processing power, memory resources, and input/output interfaces described. Furthermore, the computer 812 and its networked environment provide the necessary infrastructure for hosting RESTful services, handling client requests over HTTP protocols, and interacting with various devices and databases. Therefore, the hardware and software components shown in FIG. 8 represent a suitable and flexible computing context for deploying and executing the core functionalities of the RESTQuery system as described throughout the disclosure.

Embodiments may be implemented in or as a system, a method, an apparatus and/or a computer program product at any possible technical detail level of integration. The computer program product can include a computer readable storage medium (or media) having computer readable program instructions thereon for causing a processor to carry out aspects of the embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in one or more computing/processing device receives computer readable program instructions from the network and forwards the computer readable program instructions for storage in a computer readable storage medium within the respective computing/processing device.

Computer readable program instructions for carrying out operations of various aspects of the embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages.

The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, to perform aspects of the embodiments.

Aspects of the embodiments are described herein with reference to flowchart illustrations and/or block diagrams of methods, apparatus (systems), and computer program products according to embodiments of the invention. It can be understood that one or more blocks of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions can also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the embodiments. In this regard, one or more blocks in the flowchart or block diagrams can represent a module, segment, or portion of instructions, which comprises one or more executable instructions for implementing the specified logical function(s).

In some alternative implementations of the embodiments, the functions noted in the blocks can occur out of the order noted in the figures. For example, two blocks shown in succession can, in fact, be executed substantially concurrently, or the blocks can sometimes be executed in the reverse order, depending upon the functionality involved. It can also be noted that one or more block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art can recognize that this disclosure also can or can be implemented in combination with other program modules. Generally, program modules include routines, programs, components, data structures, etc. that perform particular tasks and/or implement abstract data types. Moreover, those skilled in the art can appreciate that the inventive computer-implemented methods can be practiced with other computer system configurations, including single-processor or multiprocessor computer systems, mini-computing devices, mainframe computers, as well as computers, hand-held computing devices (e.g., PDA, cellular phone, etc.), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” “module,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer.

By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal).

As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a server computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, the term “processor” can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein.

Further, processors can exploit nano-scale architectures such as, but not limited to, molecular and quantum-dot based transistors, switches and gates, to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

The embodiments described herein are non-abstract because they are rooted in specific, practical implementations that improve the way computing systems process and respond to REST API requests. Rather than claiming a generalized concept of querying or data filtering, the disclosed system introduces a concrete architecture, including a RESTQuery proxy situated between a client and a REST API server, which cab intercept HTTP requests and intelligently modify server responses based on client-specified parameters.

These functions can be executed through defined data structures, network configurations, and processing mechanisms, such as parsing “restquery” parameters, validating query content, and transforming JSON responses. The system operates within a tangible computing environment (e.g., proxy servers, API gateways, and programmable hardware), uses real-world communication protocols (like HTTP), and enhances the efficiency, flexibility, and usability of RESTful interfaces. As such, the claimed embodiments go beyond mere data manipulation or abstract ideas by providing a specific and novel technological solution to a technical problem—namely, the lack of built-in, customizable query capabilities in standard REST APIs.

Based on the foregoing, it can be appreciated that a number of different embodiments including preferred and alternative are disclosed. For example, in an embodiment, a system for enhancing RESTful communication, can include: a client device configured to transmit requests over a network using HTTP-based protocols, an intermediary component positioned between the client device and one or more RESTful service endpoints, the intermediary component being configured to interpret client-specified query instructions included with the request, and a backend service configured to respond to standard REST API requests, wherein the intermediary component modifies responses from the backend service based on the query instructions before transmitting the modified response to the client device.

In an embodiment, the query instructions can identify specific portions, attributes, or subsets of data within the response to be included in the modified response.

In an embodiment, the query instructions can include semantically structured or natural language-based commands to customize the returned data.

In an embodiment, the intermediary component can include logic for verifying the validity, consistency, or relevance of the query instructions prior to processing the request.

In an embodiment, the intermediary component can include one or more control mechanisms for managing resource usage or preventing malicious behavior, including rate-limiting, error handling, and query verification.

In an embodiment, a query specification framework can define queryable structures or permissible query types, the framework being distinct from existing REST documentation standards.

In an embodiment, the query instructions can be transmitted as part of a query parameter, request body, or other portion of the request data.

In an embodiment, the method for dynamically modifying responses from a RESTful API based on client-specified query instructions, can involve: receiving, at an intermediary server, a request from a client device, the request formatted in accordance with HTTP protocols and including one or more query instructions; forwarding the request to a backend RESTful service; receiving a response from the backend RESTful service; modifying the response at the intermediary server in accordance with the query instructions; and transmitting the modified response to the client device.

In an embodiment of the method, the query instructions can identify particular data elements, attributes, or nested fields to be extracted or included in the modified response.

In an embodiment of the method, the query instructions can be expressed in structured or natural language format and can be parsed by the intermediary server to determine the appropriate modifications to the response.

An embodiment of the method can further involve validating the query instructions for semantic correctness or security compliance prior to modifying the response.

An embodiment of the method can further involve applying one or more security controls at the intermediary server, including rate limiting, query complexity analysis, or response shaping, based on the content of the query instructions.

In an embodiment of the method, the query instructions can be included in a query string parameter, a request body, or a header field of the client request.

In an embodiment, a system for enhancing REST APIs with querying capabilities, can include: a client capable of sending requests using HTTP protocols; a RESTQuery proxy that sits between the client and a REST API server, wherein the proxy interprets a restquery parameter in client requests to customize the API response; and a REST API server that processes requests and returns standard REST API responses, wherein the RESTQuery proxy modifies the server response according to the client's query instructions in the restquery parameter before forwarding the response to the client.

In an embodiment, the restquery parameter can allow the client to specify particular data points or fields from the API response.

In an embodiment, the restquery parameter can support natural language instructions, allowing the client to make custom queries.

An embodiment can further include mechanisms for validating the relevance and validity of the restquery parameter before processing the request.

In an embodiment, the RESTQuery proxy can include security measures for rate-limiting, query validation, and error handling to prevent resource-intensive or malicious queries.

An embodiment can further include a RESTQuery specification format, distinct from OpenAPI, that can define the interaction between clients and the RESTQuery system.

In an embodiment, the restquery parameter can comprise a query parameter in the URL or it can be in the body of the URL.

The embodiments described herein provide a technical solution to a longstanding problem in the field of network-based client-server communications. Traditional REST API implementations are limited in their ability to deliver customized responses without proliferating endpoints, while GraphQL introduces complexity and requires backend restructuring. The disclosed RESTQuery proxy system introduces a novel middleware layer that enables fine-grained data querying through an optional parameter while preserving the stateless and lightweight nature of REST. This solution improves system performance, reduces server load, and enhances client usability by minimizing unnecessary data transmission, all of which are technical improvements in the functioning of computer networks and client-server architectures.

The disclosed subject matter is rooted in computer technology and provides improvements to the operation of computing systems themselves, rather than performing a mere abstract idea or business practice on a generic computer. Specifically, the RESTQuery proxy introduces an architectural enhancement that enables existing REST endpoints to be leveraged more efficiently without requiring backend modification. This reduces redundant network calls, avoids unnecessary endpoint creation, and allows for adaptive, context-aware response shaping. These improvements are tied to a particular system architecture, involving the coordinated operation of clients, a proxy system, and backend REST servers, thereby ensuring that the claimed invention is not an abstract concept but a concrete technological solution.

Furthermore, the system achieves technical effects that cannot be realized by manual processes or by conventional REST or GraphQL solutions alone. For example, by intercepting and interpreting client-specified parameters dynamically at runtime, the proxy system optimizes response payloads, conserves network bandwidth, and reduces processing overhead on both client and server devices. These technical advantages manifest in measurable performance gains, such as faster response times, reduced data transfer volumes, and improved scalability in distributed environments.

Unlike purely abstract ideas, the disclosed embodiments require specialized data processing operations implemented within a defined system architecture. The RESTQuery proxy leverages structured query parsing, semantic interpretation, and optional machine learning models to intelligently transform and refine server responses. This transforms the manner in which data is delivered to clients and constitutes a practical application of computing technology to solve a technical problem inherent in existing API communication paradigms.

Accordingly, the described subject matter should be understood as directed to specific improvements in computer functionality, and not as an abstract idea. The RESTQuery proxy architecture improves the efficiency, scalability, and adaptability of client-server interactions, and such improvements are necessarily rooted in technology

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A system for enhancing RESTful communication, comprising:
a client device configured to transmit requests over a network using HTTP-based protocols;
an intermediary component positioned between the client device and one or more RESTful service endpoints, the intermediary component being configured to interpret client-specified query instructions included with the request; and
a backend service configured to respond to standard REST API requests, wherein the intermediary component modifies responses from the backend service based on the query instructions before transmitting the modified response to the client device.

2. The system of claim 1, wherein the query instructions identify specific portions, attributes, or subsets of data within the response to be included in the modified response.

3. The system of claim 1, wherein the query instructions include semantically structured or natural language-based commands to customize the returned data.

4. The system of claim 1, wherein the intermediary component includes logic for verifying the validity, consistency, or relevance of the query instructions prior to processing the request.

5. The system of claim 1, wherein the intermediary component includes one or more control mechanisms for managing resource usage or preventing malicious behavior, including rate-limiting, error handling, and query verification.

6. The system of claim 1, further comprising a query specification framework for defining queryable structures or permissible query types, the framework being distinct from existing REST documentation standards.

7. The system of claim 1, wherein the query instructions are transmitted as part of a query parameter, request body, or other portion of the request data.

8. A method for dynamically modifying responses from a RESTful API based on client-specified query instructions, comprising:
receiving, at an intermediary server, a request from a client device, the request formatted in accordance with HTTP protocols and including one or more query instructions;
forwarding the request to a backend RESTful service;
receiving a response from the backend RESTful service;
modifying the response at the intermediary server in accordance with the query instructions; and
transmitting the modified response to the client device.

9. The method of claim 1, wherein the query instructions identify particular data elements, attributes, or nested fields to be extracted or included in the modified response.

10. The method of claim 1, wherein the query instructions are expressed in structured or natural language format and are parsed by the intermediary server to determine the appropriate modifications to the response.

11. The method of claim 1, further comprising validating the query instructions for semantic correctness or security compliance prior to modifying the response.

12. The method of claim 1, further comprising applying one or more security controls at the intermediary server, including rate limiting, query complexity analysis, or response shaping, based on the content of the query instructions.

13. The method of claim 1, wherein the query instructions are included in a query string parameter, a request body, or a header field of the client request.

14. A system for enhancing REST APIs with querying capabilities, comprising:
a client capable of sending requests using HTTP protocols;
a RESTQuery proxy that sits between the client and a REST API server, wherein the proxy interprets a restquery parameter in client requests to customize the API response; and
a REST API server that processes requests and returns standard REST API responses;
wherein the RESTQuery proxy modifies the server response according to the client's query instructions in the restquery parameter before forwarding the response to the client.

15. The system of claim 14, wherein the restquery parameter allows the client to specify particular data points or fields from the API response.

16. The system of claim 14, wherein the restquery parameter supports natural language instructions, allowing the client to make custom queries.

17. The system of claim 14, further comprising mechanisms for validating the relevance and validity of the restquery parameter before processing the request.

18. The system of claim 14, wherein the RESTQuery proxy includes security measures for rate-limiting, query validation, and error handling to prevent resource-intensive or malicious queries.

19. The system of claim 14, further comprising a RESTQuery specification format, distinct from OpenAPI, that defines the interaction between clients and the RESTQuery system.

20. The system of claim 14, wherein the restquery parameter comprises a query parameter in the URL or in a body of the URL.
